(19) United States
(12) Patent Application Publication
(10) Pub. No.: US 2010/0013240 A1
(43) Pub. Date: Jan. 21, 2010

(54) INLINE WATER PUMP DRIVE AND WATER COOLED STATOR

(75) Inventors: Pearl A. Wilson, Roseau, MN (US); Ronnie R. Danielson, Roseau, MN (US)

Correspondence Address: BAKER & DANIELS LLP, 300 NORTH MERIDIAN STREET, SUITE 2700, INDIANAPOLIS, IN, 46204, US

(73) Assignee: Polaris Industries Inc., Medina, MN (US)

(21) Appl. No.: 12/236,058

(22) Filed: Sep. 23, 2008

Related U.S. Application Data
(60) Provisional application No. 61/081,269, filed on Jul. 16, 2008.

(51) Int. Cl. H02K 7/18

(52) U.S. Cl. 290/1 A; 415/3.1

(57) ABSTRACT

An all-terrain vehicle is shown including an engine with a water pump, generator, and crankshaft having a common axis of rotation. The water pump and generator share a common wall to transfer heat from the generator to the water pump.

### CROSS-REFERENCE TO RELATED APPLICATIONS

The present application claims priority to U.S. Provisional Patent Application Ser. No. 61/081,269, filed Jul. 16, 2008, titled “INLINE WATER PUMP DRIVE AND WATER COOLED GENERATOR,” to Wilson et al, the entire disclosure of which is expressly incorporated by reference herein.

### FIELD OF THE INVENTION

The subject invention relates to a vehicle having a generator and water pump.

### BACKGROUND OF THE INVENTION

Many engines require a cooling system to discharge excess heat. Some engines are air cooled and other are water cooled. Most water cooled systems use a water pump to circulate water (i.e. coolant) through the system.

Many vehicles include electrical power generation systems to provide electrical power to the vehicle. The electrical power may be used to operate the engine by providing power to the spark plugs, engine controls, and other electrical engine controls. The electrical power may also be used to power other electric vehicle components, such as lights, power steering, electrical outlets, etc.

### SUMMARY OF THE INVENTION

According to a first aspect of the invention, an engine for a vehicle is provided including an engine block assembly, a plurality of pistons positioned in the engine block assembly, a crankshaft positioned in the engine block assembly and driven by the plurality of pistons, a generator configured to provide electrical power, and a water pump having an impeller to circulate coolant through the engine block assembly to cool the engine. The generator and water pump have coincident axes of rotation.

According to another aspect of the invention, an engine for a vehicle is provided including an engine block assembly, a plurality of pistons positioned in the engine block assembly, a crankshaft positioned in the engine block assembly and driven by the plurality of pistons, and a generator and water pump assembly configured to provide electrical power and circulate coolant through the engine block to cool the engine. The generator and water pump assembly includes a housing having a wall defining at least a portion of an interior impeller region including a coolant and an interior generator region, an impeller positioned in the impeller region to pump the coolant, and a generator positioned in the interior generator region to provide electrical power. The wall transfers heat from the generator to the coolant.

According to another aspect of the invention, an engine for a vehicle is provided including an engine block assembly, a plurality of pistons positioned in the engine block assembly, a crankshaft positioned in the engine block assembly and driven by the plurality of pistons, and a water pump circulating coolant through the engine block assembly to cool the engine. The engine block assembly includes at least one block having a coolant passage passing coolant pressurized by the water pump and an oil passage parallel to the coolant passage passing oil. The block including a wall separating the coolant passage from the oil passage and transferring heat from the oil in the oil passage to the coolant in the coolant passage.

According to another aspect of the present invention, an engine for a vehicle is provided including an engine block assembly defining a water jacket, a plurality of pistons positioned in the engine block assembly, a crankshaft positioned in the engine block assembly and driven by the plurality of pistons, and a water pump circulating coolant through the water jacket to cool the engine. The water jack has an inlet and an outlet, at least one of the inlet and outlet being positioned adjacent to the substantially uppermost portion of the water jacket.

The above mentioned and other features of this invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 is a perspective view of a vehicle;

FIG. 2 is a perspective view of an engine for use in the vehicle of FIG. 1;

FIG. 3 is another perspective view of the engine of FIG. 2;

FIG. 4 is a cross-sectional view of the engine of FIG. 2 through line 4-4 of FIG. 2;

FIG. 5 is an enlarged view of a portion of FIG. 4;

FIG. 6 is a side elevation view of a portion of the engine of FIG. 2;

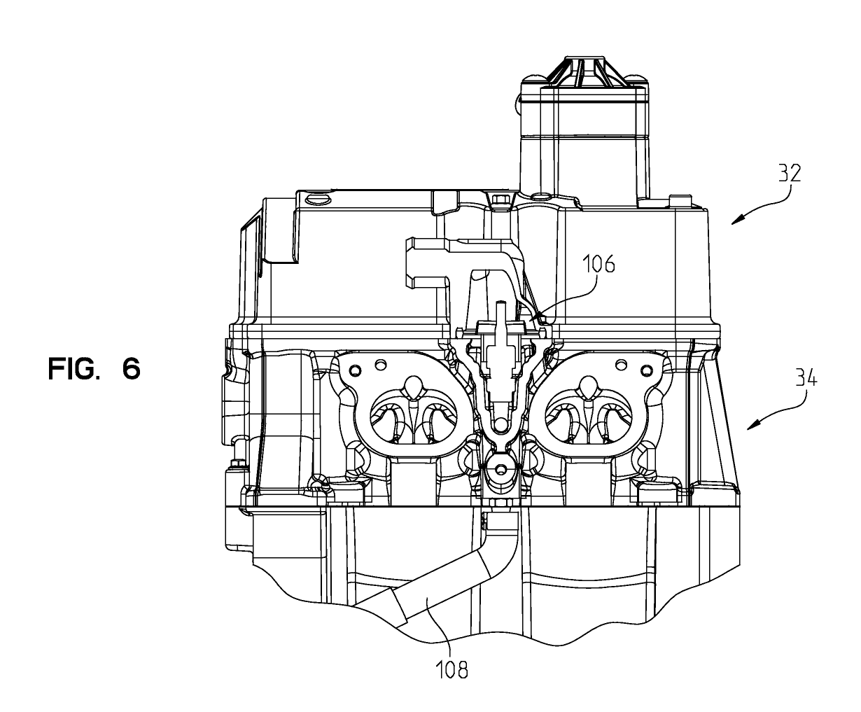

FIG. 7 perspective view of the engine block assembly of the engine of FIG. 2;

FIG. 8 is a cross-sectional view through line 8-8 of FIG. 2;

FIG. 9 is a cross-section view of the engine block through line 9-9 of FIG. 8; and

FIG. 10 is a top plan view of the engine block assembly of FIG. 7.

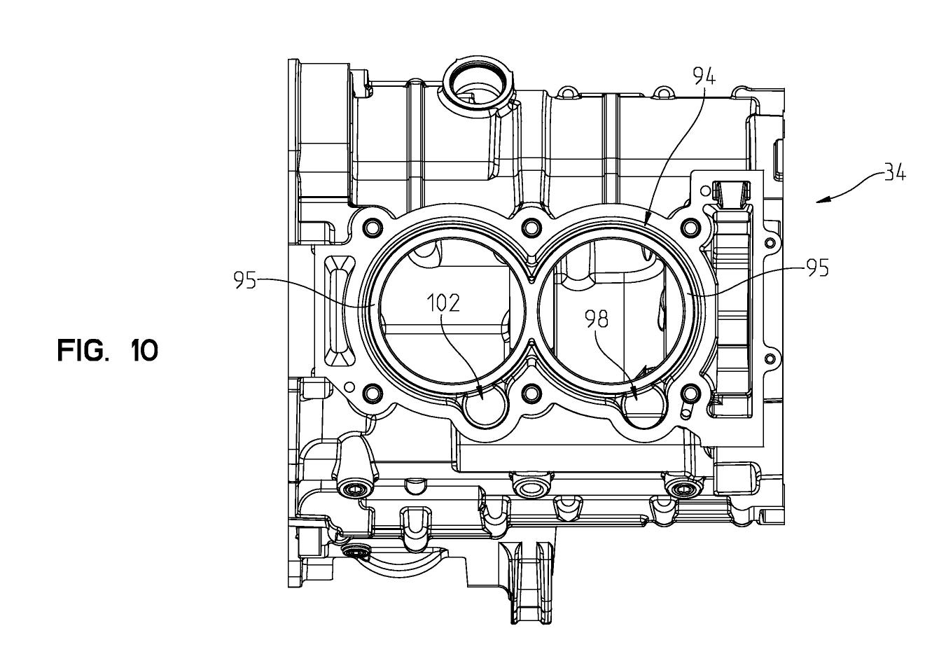

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. For example, while the following description refers primarily to an all terrain vehicle, it should be understood that the invention may have application to other types of vehicles, such as snowmobiles, motorcycles, watercraft, utility vehicles, scooters, golf carts, and mopeds.

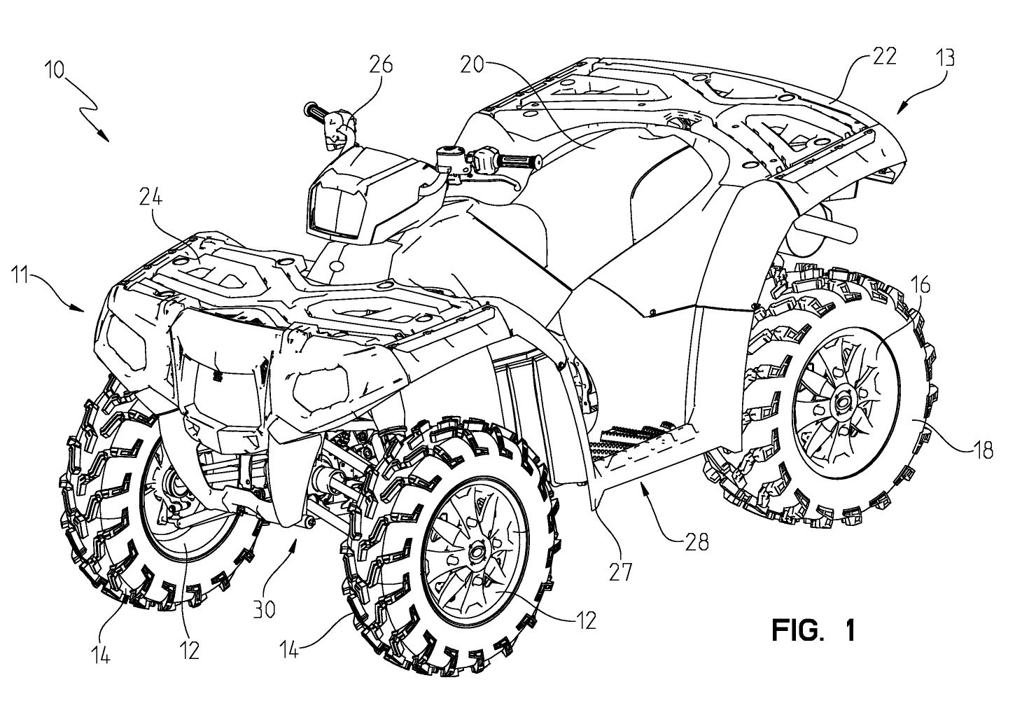

Referring initially to FIG. 1, one illustrative embodiment of an all terrain vehicle (ATV) 10 is shown. ATV 10 includes front end 11, rear end 13, straddle-type seat 20, and handlebar assembly 26. Front end 11 and rear end 13 are separated by footwells 28 on both lateral sides of ATV 10 and separated by seat 20. Front end 11 is supported by front wheels 12 and tires 14 and front suspension 30. Front end 11 also includes front panel 24 which may include a tool storage compartment. Handlebar assembly 26 is operably coupled to front wheels 12 to allow a rider to steer ATV 10 when supported by seat 20 and/or footwells 28. Rear end 13 is supported by rear wheels 16 and tires 18. Rear end 13 also includes rear panel 22 which may include a tool storage compartment. Front panel 24 and rear panel 22 may also include an accessory coupling system such as the one disclosed in U.S. Pat. No. 7,055,454, the disclosure of which is expressly incorporated by reference herein. Side panels 27 may be coupled intermediate front and rear panels 24, 22.

Front tires 14 extend forward of forward most components of ATV 10, illustratively front panel 24, and may act as a front “bumper” for ATV 10. As such, front tires 14 are configured to prevent damage to ATV 10 or a transporting vehicle, especially if ATV 10 is transported in a pickup truck bed or similar vehicle. Additional details of ATV 10 are provided in U.S. patent application Ser. No. 12/069,515, filed Feb. 11, 2008, titled “Drivetrain for an all terrain vehicle,” to Bennett et al., the entire disclosure of which is expressly incorporated by reference herein.

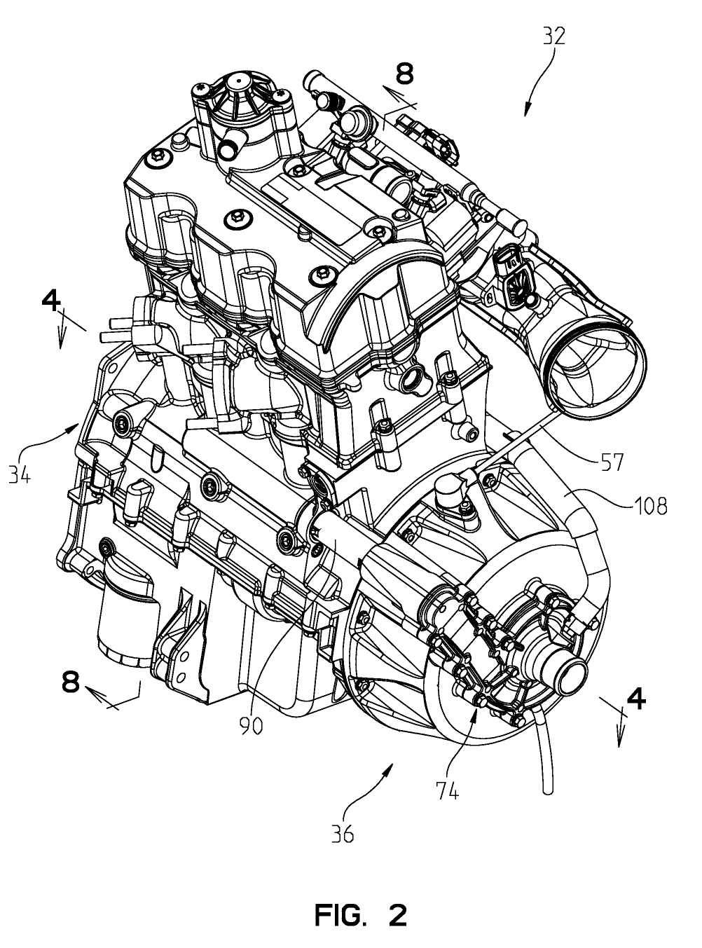

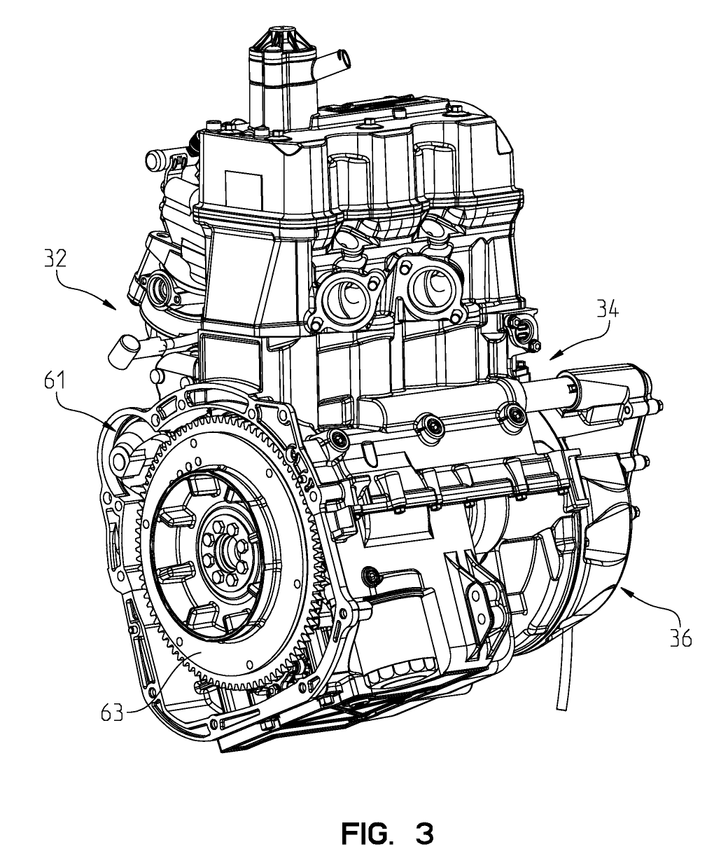

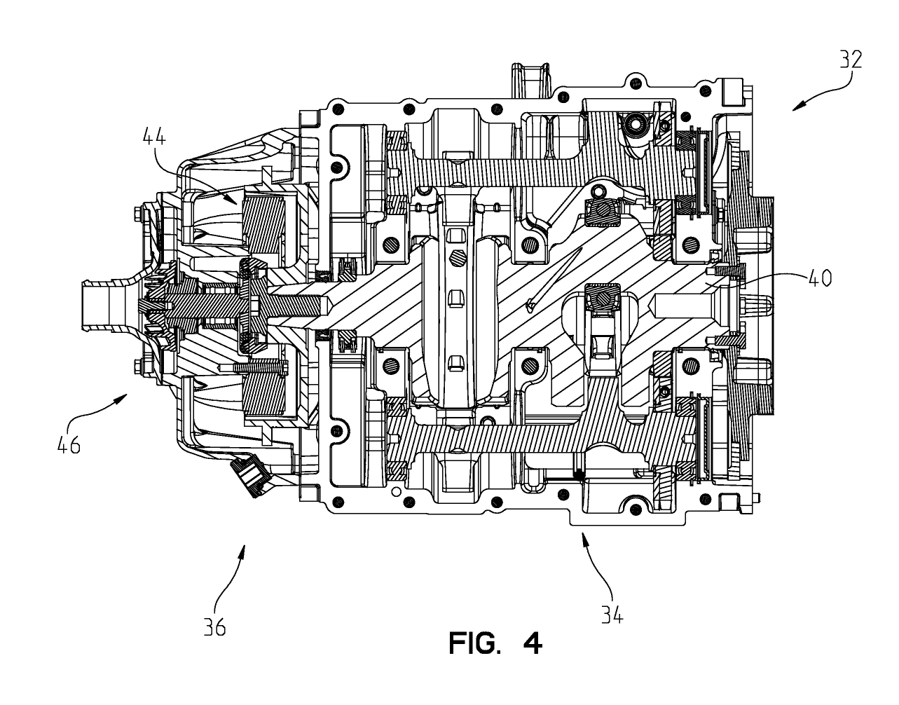

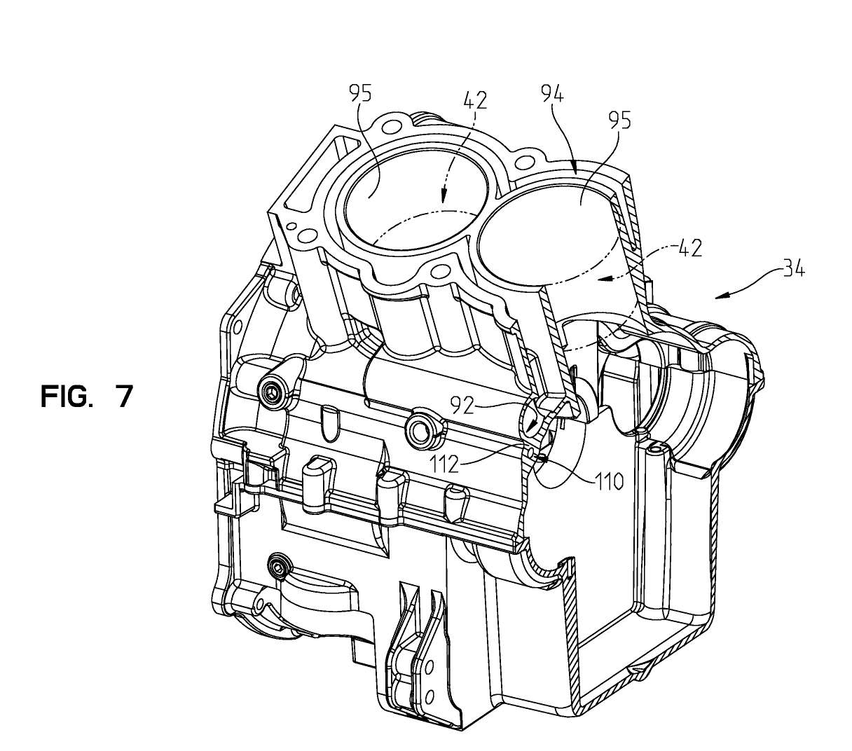

With reference first to FIGS. 2 and 3, a four cycle in-line two cylinder engine is shown at 32 comprised of an engine block assembly 34 and a generator and water pump assembly 36 coupled to engine block assembly 34. As shown in FIG. 4, engine 32 further includes a crankshaft 40 positioned in engine block assembly 34 and coupled to pistons 42 (shown in phantom in FIG. 7) to provide rotational power. Crankshaft 40 is coupled to generator and water pump assembly 36 to provide rotational power thereto.

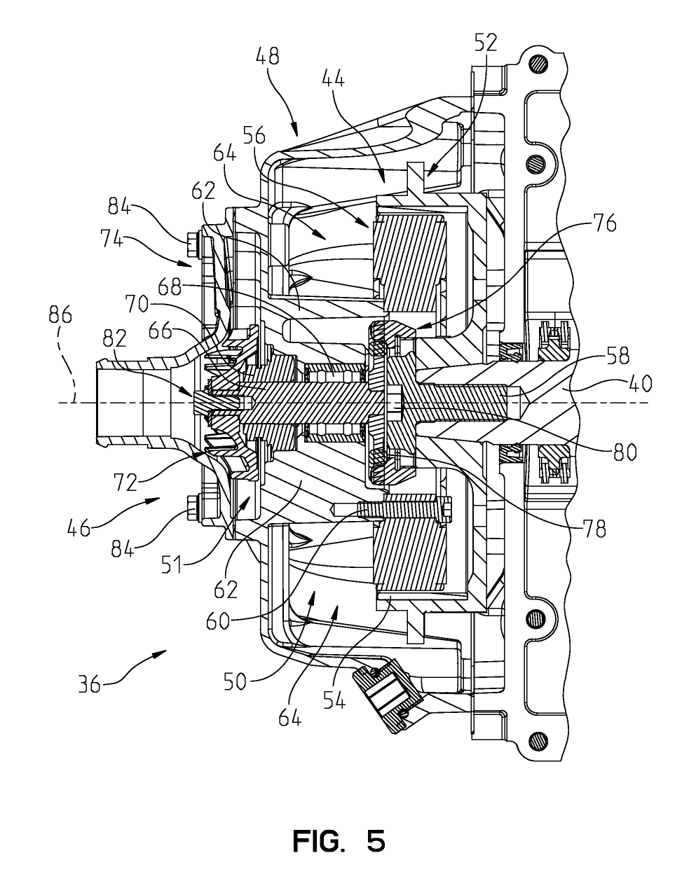

As shown in FIG. 5, generator and water pump assembly 36 includes a generator 44 coupled directly to crankshaft 40 and a water pump 46 coupled to generator 44 so that generator 44 is positioned between water pump 46 and engine block assembly 34. According to an alternative embodiment, the water pump is positioned between the generator and the engine block assembly.

Generator 44 and water pump 46 share a common housing 48 so that heat generated on a generator side 50 of housing 48 transfers to coolant on a water pump side 51 of housing 48. By transferring the heat from generator 44 to the coolant, the output of generator 44 can be increased without overheating.

Generator 44 includes a stator flywheel 52 including a plurality of permanent magnets 54 and a stator winding 56 positioned within flywheel 52. Flywheel 52 is coupled to crankshaft 40 by a bolt 58. Similarly, stator winding 56 is coupled to housing 48 by a plurality of bolts 60. During operation, magnets 54 rotate around winding 56 to induce an electric current in winding 56. A rectifier (not shown) receives the alternating current from winding 56 through electrical connector and wire 57 (shown in FIG. 2) and provides a 14 volt direct current to vehicle 10. The power output by winding 56 is dependent on the speed of engine 32. At an engine idle speed of about 1200 RPM, generator 44 provides about 450 Watts of power. At about 4500 RPM and above, generator 44 provides about 575 Watts of power.

The power provided by generator 44 powers operation of engine 32 and other components of ATV 10. For example, generator 44 powers the spark plugs, EFI system of engine 32, a solenoid engaged starter 61 (shown in FIG. 3), electronic controls, lights, and other electrical components of ATV 10. Starter 61 includes a solenoid that moves starter 61 into engagement with ring gear 63 to start rotation of engine 32 until a predetermined speed then disengages starter 61 from ring gear 63 after engine 32 starts.

As shown in FIG. 5, winding 56 is in direct annular contact with housing 48. This direct contact transfers heat from winding 56 through webs 62 of housing 48. Webs 62 transfer this heat to coolant within water pump 46. During operation, oil or air-filled cavities 64 on generator side 50 of housing 48 receive heat from winding 56. This heat is transferred from the oil or air to housing 48 and then transferred to the coolant. As a result of this heat transfer, less heat builds up in generator 44 to avoid overheating.

Water pump 46 includes a pump shaft 66, a bearing 68 press fit into housing 48, a ceramic seal 70, an impeller 72, and a cover 74. Pump shaft 66 and generator 44 mate at an interface 76 that includes a rubber dampener 78 to reduce shock transferred from generator 44 to pump 46. Pump shaft 66 is coupled to interface 76 by a nut 80 and impeller 72 is coupled to shaft 66 by bolt 82. Cover 74 is coupled to housing 48 by bolts 84.

As shown in FIG. 5, crankshaft 40, generator 44, and water pump 46 share a common axis of rotation 86 that extends through an input 88 to water pump 46. According to alternative embodiments of the present disclosure, crankshaft 40, generator 44, and water pump 46 do not share a common axis of rotation. For example, according to one alternative embodiment, generator 44 and water pump 46 are radially or otherwise spaced apart from the axis of rotation of crank shaft 40 and are directly driven by another device, such as a belt or chain, that may be directly or indirectly driven by crankshaft 40. In such an alternative embodiment, generator 44 and water pump 46 may be positioned adjacent one another to transfer waste heat from generator 44 to water pump 46.

Input 88 is coupled to the vehicle radiator (not shown). As shown in FIG. 2, water (also referred to as coolant), travels through cover 74 to tube 90 and into engine block assembly 34. Water then flows through engine block assembly 34 through an internal passage 92 shown in FIGS. 7-9. From passage 92, the water flows into a water jacket 94 formed around piston cylinders 95 of engine block assembly 34. Water travels from passage 92 into a first cylinder 96 of water jacket 94 through a first port 98 and into a second cylinder 100 of water jacket 94 through a second port 102.

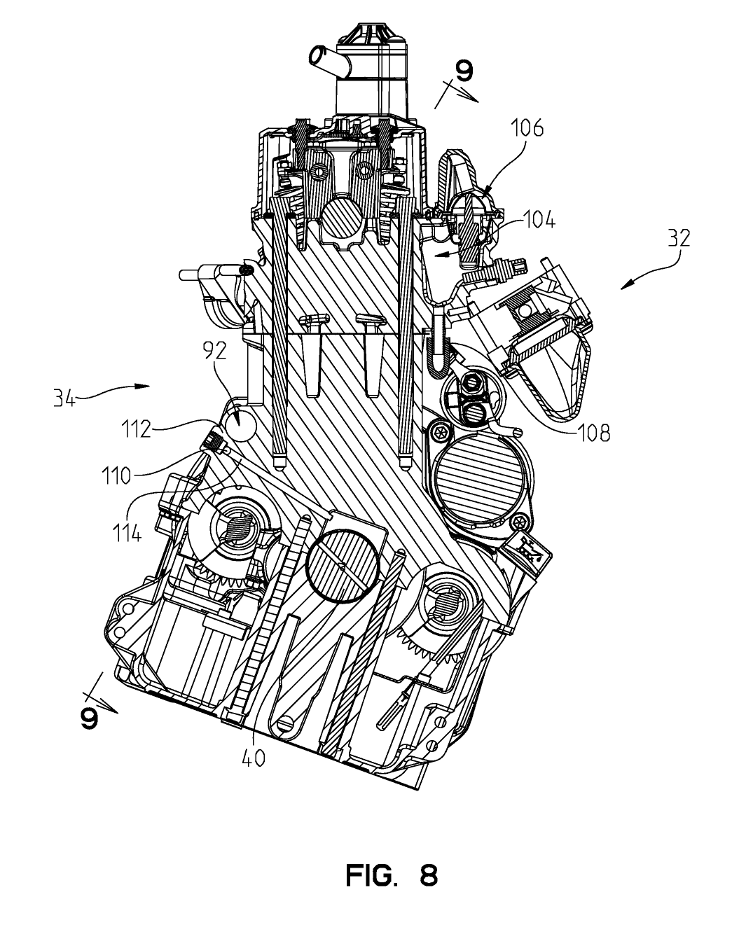

From first and second cylinders 96, 100 of water jacket 94, the water flows to an uppermost cavity 104 (shown in FIG. 8) of water jacket 94 that receives an engine thermostat 106. By positioning cavity 104 at the uppermost point of water jacket 94, air is less likely to collect in water jacket 94 that could otherwise create undesirable cavitation. As shown in FIG. 8, uppermost cavity 104 and thermostat 106 are positioned direction over crankshaft 40, portions of the pistons, and portions of piston cylinders 96,100.

Water pump 46 is located at a low point in the circulation path of the coolant. For example, water pump 46 is the lowest point in the flow path of the coolant through engine 32. Furthermore, water pump 46 is at least as low or lower than the lowest point of coolant in the radiator. By positioning water pump 46 at the low point in the coolant flow path, the largest water pressure head is provided to input 88 of pump 46 resulting in greater pressure output from water pump 46.

A bypass hose 108 is coupled to a lower portion of uppermost cavity 104 and extends to water pump 46 as shown in FIG. 2. Another hose (not shown) is coupled to thermostat 106 and extends to the radiator. During startup, thermostat 106 detects the temperature of the coolant. Below a predetermined temperature, thermostat 106 closes (partially or completely) so that little or no coolant flows to the radiator and most or all of the coolant is circulated back through engine 32. Once the coolant is above the predetermined temperature, thermostat 106 opens and passes coolant to the radiator so the coolant is cooled.

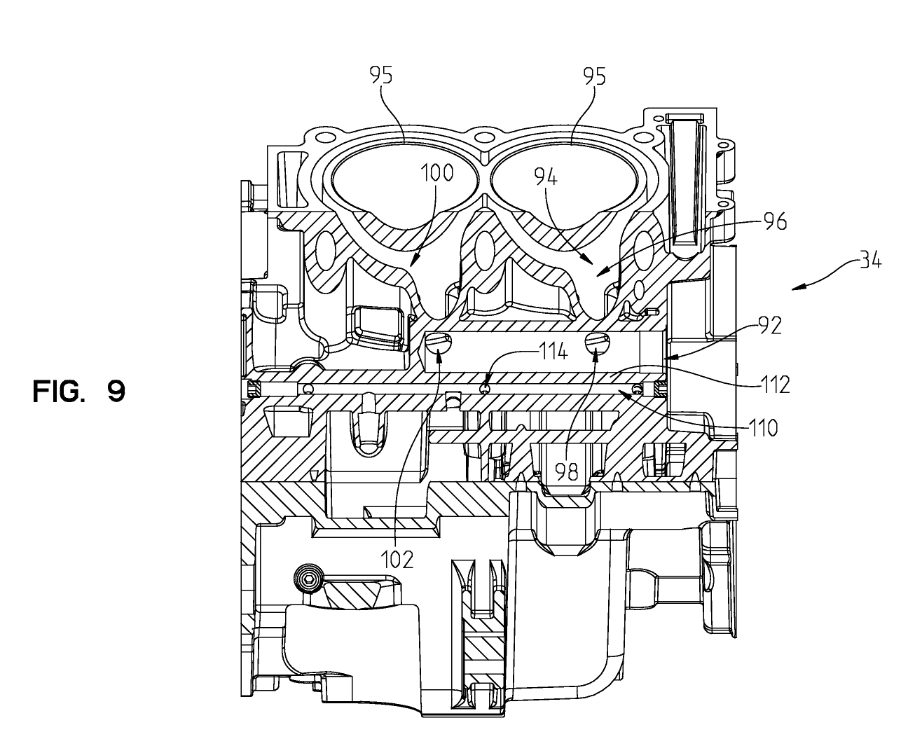

Referring again to FIG. 7, engine block assembly 34 further includes an lubricant or oil passage 110. As shown in FIG. 9, oil passage 110 is substantially parallel to coolant passage 92 so that passages 92, 110 share a common wall 112 therebetween. By sharing common wall 112, heat passes from oil in passage 110 to coolant in passage 92. By transferring the heat, the oil is cooled and the coolant is heated.

Oil passage 110 feeds oil to smaller passages that provide oil to various engine components. For example, passage 114 receives oil from oil passage 110 and provides oil to crankshaft 40. Additional details of the lubrication system of engine 32 are provided in U.S. patent application Ser. No. 12/218,528, filed Jul. 16, 2008 to Michael J. Bluhm, titled “Wet Oil Sump for Four Cycle Engine,” the entire disclosure of which is expressly incorporated by reference herein.

According to a preferred method of assembling engine 32, most of generator and pump assembly 36 is assembled before mounting on engine block assembly 34. For example, stator winding 56 and impeller 72 and the remainder of water pump 46 are coupled to housing 48 before housing 48 is coupled to engine block assembly 34. After being coupled to housing 48, the output of pump 46 is tested and pump 46 is checked for leaks. Similarly, the output of stator winding 56 is tested.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. An engine for a vehicle including
an engine block assembly,
a plurality of pistons positioned in the engine block assembly,
a crankshaft positioned in the engine block assembly and driven by the plurality of pistons,
a generator configured to provide electrical power, and
a water pump having an impeller to circulate coolant through the engine block assembly to cool the engine, the generator and water pump having coincident axes of rotation.

2. The engine of claim 1, wherein the generator is positioned between the water pump and the engine block assembly.

3. The engine of claim 1, wherein the water pump includes an inlet and an outlet and the axis of rotation of the generator and the crankshaft extends through at least one of the inlet and outlet of the water pump.

4. The engine of claim 1, wherein the water pump and generator are included in a generator and water pump assembly including a housing have a wall positioned between water pump and the generator and transferring heat from the generator to coolant pumped through the engine by the water pump.

5. The engine of claim 1, wherein the generator and water pump share a common housing having a wall positioned between an impeller of the water pump and a stator winding of the generator.

6. The engine of claim 1, wherein the axis of rotation of the crankshaft is coincident with the axes of rotation of the generator and the water pump.

7. An engine for a vehicle including
an engine block assembly,
a plurality of pistons positioned in the engine block assembly,
a crankshaft positioned in the engine block assembly and driven by the plurality of pistons, and
a generator and water pump assembly configured to provide electrical power and circulate coolant through the engine block to cool the engine, the generator and water pump assembly including
a housing having a wall defining at least a portion of an interior impeller region including a coolant and an interior generator region,
an impeller positioned in the impeller region to pump the coolant, and
a generator positioned in the interior generator region to provide electrical power, the wall transferring heat from the generator to the coolant.

8. The engine of claim 7, wherein the coolant in the impeller region is in direct contact with the wall and the generator is in direct contact with the wall.

9. The engine of claim 7, wherein the generator and water pump assembly further includes an impeller shaft coupled to the generator.

10. The engine of claim 7, wherein the generator includes a stator winding and a magnetic rotor and the stator winding is positioned within the magnetic rotor.

11. The engine of claim 7, wherein the wall supports an impeller bearing on which the impeller rotates.

12. An engine for a vehicle including
an engine block assembly,
a plurality of pistons positioned in the engine block assembly,
a crankshaft positioned in the engine block assembly and driven by the plurality of pistons, and
a water pump circulating coolant through the engine block assembly to cool the engine, the engine block assembly including at least one block having a coolant passage passing coolant pressurized by the water pump and an oil passage parallel to the coolant passage passing oil, the block including a wall separating the coolant passage from the oil passage and transferring heat from the oil in the oil passage to the coolant in the coolant passage.

13. The engine of claim 12, wherein the oil in the oil passage has a higher operating temperature than the coolant.

14. The engine of claim 12, wherein the oil in the oil passage is in direct contact with the wall and the coolant in the coolant passage is in direct contact with the wall.

15. The engine of claim 12, wherein the oil passage includes a plurality of ports and the coolant passage includes a plurality of ports.

16. The engine of claim 12, wherein the engine block assembly includes a plurality of cylinders receiving the plurality of pistons and the wall is integral with the cylinders.

17. An engine for a vehicle including
an engine block assembly defining a water jacket,
a plurality of pistons positioned in the engine block assembly,
a crankshaft positioned in the engine block assembly and driven by the plurality of pistons, and
a water pump circulating coolant through the water jacket to cool the engine; the water jack having an inlet and an outlet, at least one of the inlet and outlet being positioned adjacent to the substantially uppermost portion of the water jacket.

18. The engine of claim 17, wherein the engine further includes a thermostat positioned in the upper most portion of the water jacket.

19. The engine of claim 17, wherein the uppermost portion of the water jack is positioned direction above the crankshaft.

20. The engine of claim 17, wherein the uppermost portion of the water jack is laterally of a central axis of the plurality of pistons and vertically above the pistons.

21. The engine of claim 17, wherein the engine includes a coolant exit positioned above the uppermost portion of the water jacket.
